(19) United States
(12) Patent Application Publication
(10) Pub. No.: US 2017/0046350 A1
(43) Pub. Date: Feb. 16, 2017

(54) MEDIA ORGANIZATION

(71) Applicant: Hewlett-Packard Development Company, L.P., Houston, TX (US)

(72) Inventors: Eric Michael Lunsford, Sunnyvale, CA (US); Mark E Gorzynski, Corvallis, OR (US); Donald Gonzalez, Redwood City, CA (US)

(21) Appl. No.: 15/306,919

(22) PCT Filed: Sep. 24, 2014
(86) PCT No.: PCT/US2014/057287

§ 371 Date: Oct. 26, 2016

(51) Int. Cl. G06F 17/30

(52) U.S. Cl. CPC G06F 17/30058; G06F 17/30601; G06F 17/30117

(57) ABSTRACT

Examples are disclosed herein for media organization. An example method includes analyzing media in a database to determine content of the media; sorting the media based on the content into a plurality of groups; identifying a media file that does not belong to at least one of the plurality of groups based on content of the media file and the content of the media; and in response to identifying that the media file does not belong to at least one of the plurality of groups, tagging the media file to cause the media file to be removed from the database.

### BACKGROUND

Digital media has enabled users to capture and maintain images, video and/or audio with increased ease. With advances in camera technology users are able to capture images and/or video on a plurality of devices, such as smartphones, table computers, laptop computers, etc. in addition to cameras and/or video recorders. Furthermore, advances in memory technology enable users to store and/or access vast amounts of media (e.g., images, video, audio, etc.).

### BRIEF DESCRIPTION OF THE DRAWINGS

FIG. 1 illustrates a schematic diagram of an example media management system including an example media manager and media removal manager implemented in accordance with this disclosure.

FIG. 2 is a block diagram of an example media manager including an example media removal manager that may be used to implement the media manager of FIG. 1.

FIG. 3 is a block diagram of an example media removal manager that may be implemented by the media manager of FIGS. 1 and/or 2.

FIGS. 4A-4C illustrate an example graphical user interface that may be used to implement and/or control the example media manager of FIGS. 1 and/or 2.

FIG. 5 is a flowchart representative of example machine readable instructions that may be executed to implement the media manager of FIG. 2.

FIG. 6 is another flowchart representative of example machine readable instructions that may be executed to implement the media manager of FIG. 2.

FIG. 7 is yet another flowchart representative of example machine readable instructions that may be executed to implement the media manager of FIG. 2.

FIG. 8 is a still another flowchart representative of example machine readable instructions that may be executed to implement the media manager of FIG. 2.

FIG. 9 is a block diagram of an example processor platform capable of executing the instructions of FIGS. 5, 6, 7, and/or 8 to implement the media manager of FIG. 2 and/or the media removal manager of FIG. 3.

Wherever possible, the same or similar reference numbers will be used throughout the drawing(s) and accompanying written description to refer to the same or like parts.

### DETAILED DESCRIPTION

Examples disclosed herein provide for organization of media. In some examples, content and/or metadata of media is analyzed and/or tagged to be sorted in groups. Example groups of media and unsorted media may be presented to users as disclosed herein. In some examples, media may be automatically removed from a database based on content and/or metadata associated with the media and/or user behavior for deleting media corresponding to certain groups and/or unsorted media. Accordingly, examples disclosed herein provide for more efficient media management and/or organization to enable a use to easily access media, view media, edit media, sort media, assign metadata to media, present media, and/or delete media.

Examples disclosed herein provide for automatic identification and/or removal of media from a database based on content and/or metadata of the media. Recently, user's collections of media have substantially grown with the advent of digital cameras and camera technology on mobile phones, tablet computers, etc. Accordingly, navigating through such a vast amount of media may prove to be extremely difficult and nearly impossible. In some examples, disclosed herein, a media database may be managed by automatically removing media from the database to manage the size of a media collection. Example media may be tagged for removal based on content of the media and/or metadata associated with the media. As a more specific example, a media manager may remove an image of a product that a user captures in a store as it is likely an image that the user may only temporarily desire to keep. In such an example, a media manager may identify that the image is of a product (e.g., by identifying the product and/or object using image processing) and associating metadata (e.g., determining a location (a retail store) that the image was captured, a time the image was taken (e.g., middle of the day, between other events, a same time as another similar image, etc)). Accordingly, examples disclosed herein may be used for media management and/or media organization.

An example method disclosed herein includes analyzing, via a processor, media in a database to determine content of the media; sorting the media based on the content into a plurality of groups; identifying a media file that does not belong to at least one of the plurality of groups based on content of the media file and the content of the media; and in response to identifying the media file, in response to identifying that the media file does not belong to at least one of the plurality of groups, tagging the media file to cause the media file to be removed from the database. As used herein, media and/or data being removed and/or removal from a database may include deleting, erasing, clearing, overwriting, etc. an address, register, entry, etc. of the database corresponding to the media and/or data.

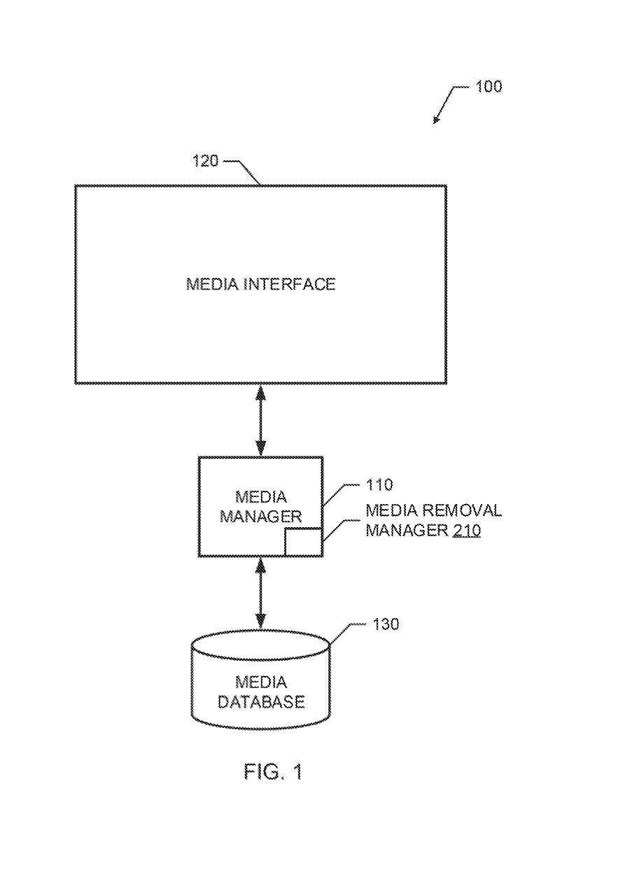

FIG. 1 is a schematic diagram of an example media management system 100 including an example media manager 110 constructed in accordance with the teachings of this disclosure. The example media management system 100 may be implemented by any type of system or device, such as a computer, a tablet computer, a smartphone, or any other type of computing device. The example media management system 100 of FIG. 1 includes the media manager 110, including a media removal manager 210, a media interface 120, and a media database 130. In the illustrated example of FIG. 1, the media manager 110 is communicatively coupled to the media interface 110 and the media database 130. In some examples, the media manager 110 may be collocated with the media interface 120 and/or the media database 130 on a same device (e.g., a tablet computer, a laptop computer, etc.).

In the illustrated example of FIG. 1, the media interface 120 may be implemented by a display device (e.g., a liquid crystal display (LCD), a light emitting diode (LED) display, a touchscreen display etc.), an input device (e.g., a touchscreen, a mouse, a trackpad, etc.), and/or any corresponding circuitry for establishing a connection to the media interface 120. Accordingly, in FIG. 1, a user may interact with media via the media interface 120. For example, a user may access, view, edit, and/or present media via the media interface 120. In examples disclosed herein, the media interface 120 may be capable of interpreting gestures made by a user and/or captured by the media interface 120 to facilitate interaction with the media. As used herein, gestures may be any type of movement by a user, movement of a control device, contact on a touchscreen, (or touchpad) etc. In some examples, the media interface in may be used by a user to input queries to search for and/or organize media in the media database 130. Input queries may be text based queries and/or other actions such as voice commands. In some examples, the media interface 120 may be capable of identifying voice commands and/or using voice recognition to interact with the media system 100 of FIG. 1.

The example media database 130 may be any type of memory device (e.g., a non-volatile memory device, a volatile memory device, etc.). The example media database 130 stores media (e.g., image data, video data, audio data) that may be rendered and/or presented via the media interface 120,

The example media manager 110 of FIG. 1 facilitates access, organization, editing, and/or presentation of media via the media interface 110 and/or the media database 130. The media manager 110 of FIG. 1 includes an example media removal manager 210 constructed in accordance with the teachings of this disclosure. The example media manager 110 may monitor the media database 130 for newly added media (e.g., new pictures and/or video received via a camera device of the media management system 100 and/or a camera device in communication with the media management system 100) and/or queries for media from a user. In some examples, the media manager 110 sorts the media based on at least one of time, date, location, content, quality and/or a query requesting media. For example, the media manager 110 may create and/or facilitate associating tags and/or identifiers with media based on when, where, who, or what is in an image, video, and/or audio file. In accordance with the teachings of this disclosure, images may be automatically and/or manually identified and/or tagged as being motion-blurred, being out of focus, being overexposed/under-exposed, being an unneeded duplicate, having red eye, etc. Furthermore, images may be automatically and/or manually identified and/or tagged as landscape vs portrait, black & white vs color vs sepia, composite vs. stand-alone, panorama vs non-panorama, etc. Similarly, example audio clips may be automatically and/or manually identified and/or tagged as being too loud, too soft, including or not including music, having specifically identifiable instruments (e.g., violin, trumpet, voice, etc.), being capable of voice recognition and/or translation to text, etc.

In some examples, the media manager 110 facilitates access to the media database 130 for a user. For example, the media manager 110 may alert a user that a newly received image has been received and/or has/has not been assigned to a particular group of media. In some examples, the media manager 110 may suggest particular groups of media that a particular image, video file, and/or audio clip is to be assigned. Additionally or alternatively, the media manager 110 may create and/or facilitate creation of projects (e.g., slide shows, video presentations, etc.) including the media of the media database 130. Accordingly, the media manager 110, in accordance with the teachings of this disclosure, enables a user to access, view, organize, and/or present media in an efficient manner.

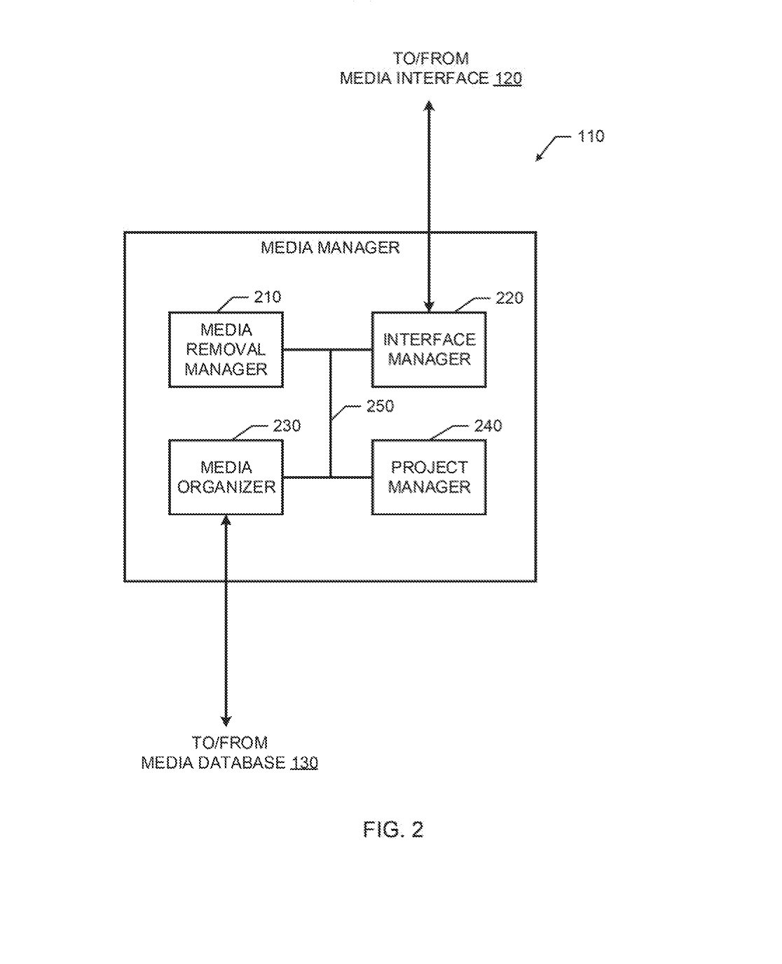

FIG. 2 is a block diagram of an example media manager 110 that may be used to implement the media manager 110 of FIG. 1. The media manager 110 in the illustrated example of FIG. 2 includes a media removal manager 210, an interface manager 220, a media organizer 230, and a project manager 240. In the illustrated example of FIG. 2, a communication bus 250 facilitates communication between the media removal manager 210, the interface manager 220, the media organizer 230, and/or the project manager 240.

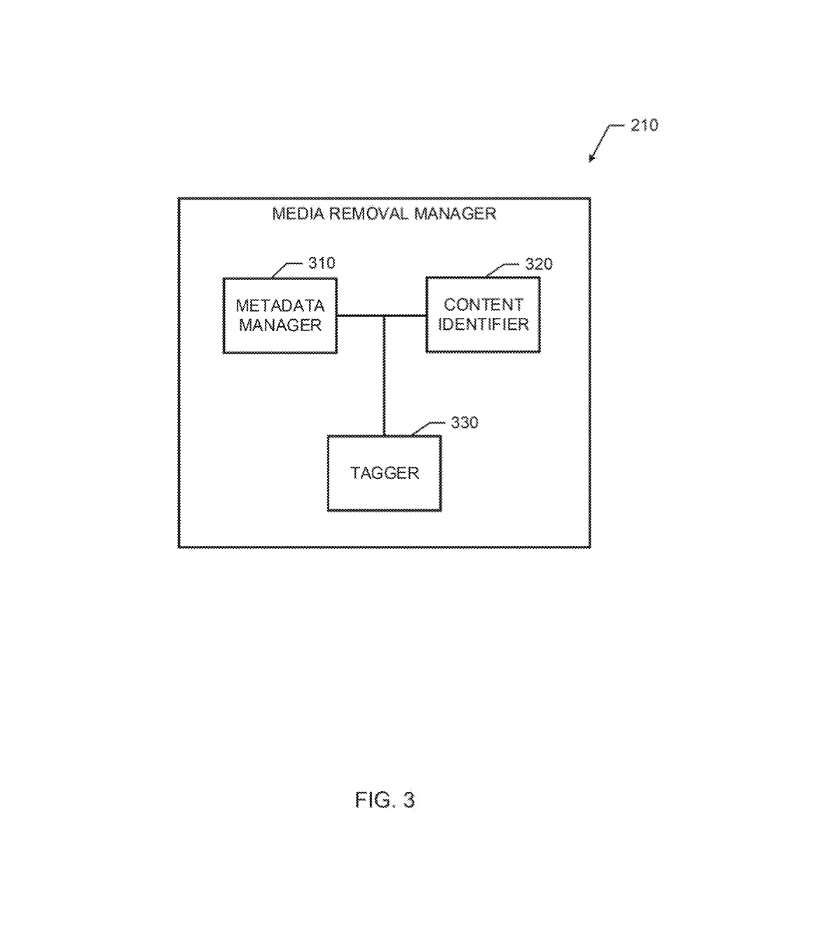

The example media removal manager 210 of FIG. 2 analyzes media in the media database 130 of FIG. 1. In some examples, the media removal manager 210 monitors the media database 130 for newly received media by identifying when new media data is created and/or stored in the media database 130. Furthermore, the media removal manager 210 may identify metadata (e.g., time information, location information, format, etc.) associated with the media, quality of the media, and/or content of the media (e.g., objects, persons, text, symbols, a source, a document, etc, in a document, in an image, in a video, and/or in an audio recording). An example implementation of the media removal manager 210 is described below in connection with FIG. 3.

The example interface manager 220 serves as an interface between the media manager 110 of FIG. 2 and the media interface 120 of FIG. 1. The example interface manager may be any interface circuit and/or communication port that facilitates communication between the media manager 110 and the media interface 120. For example, the media manager 110 may receive commands via the interface manager 220 from a user providing instructions (e.g., via gestures) via the media interface 120. Furthermore, the media manager 110 may send alerts via the interface manager 220 to the media interface 120. Accordingly, the interface manager 220 may send alert messages and/or reports to be presented via the media interface 120 in response to receiving notifications for events managed by the media manager 110 and/or operations performed by the media manager 110. For example, such notifications, alerts, and/or reports may reflect that newly received media was identified, a project was completed, media file(s) was/were sorted, media was edited, media has not been sorted, etc.

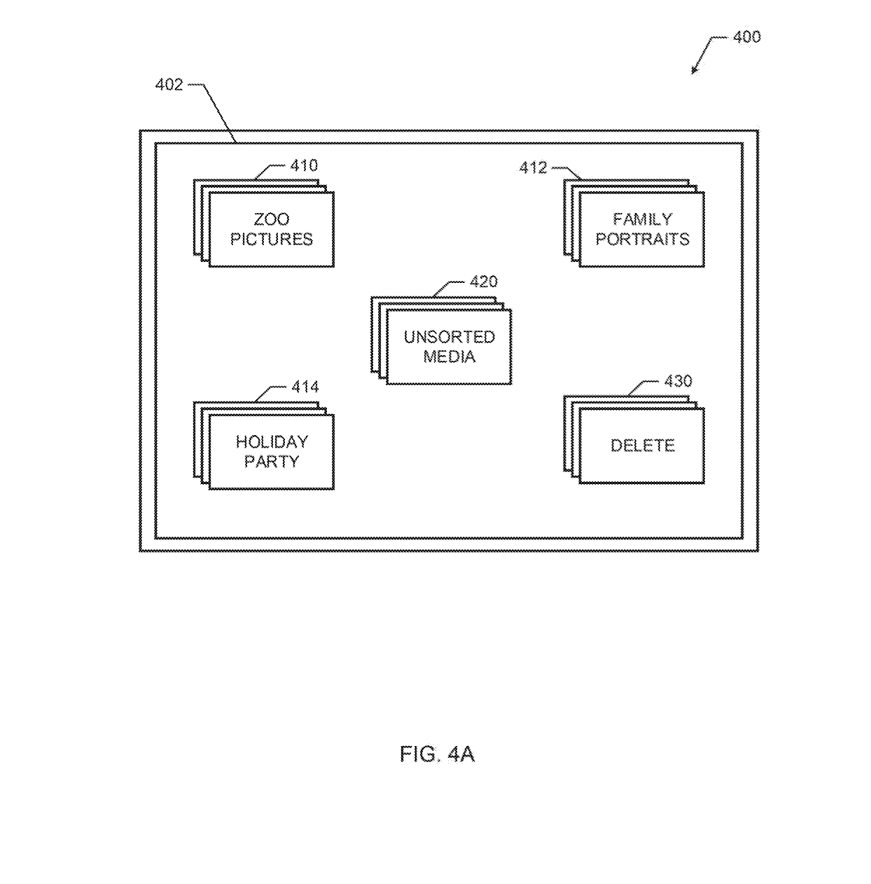

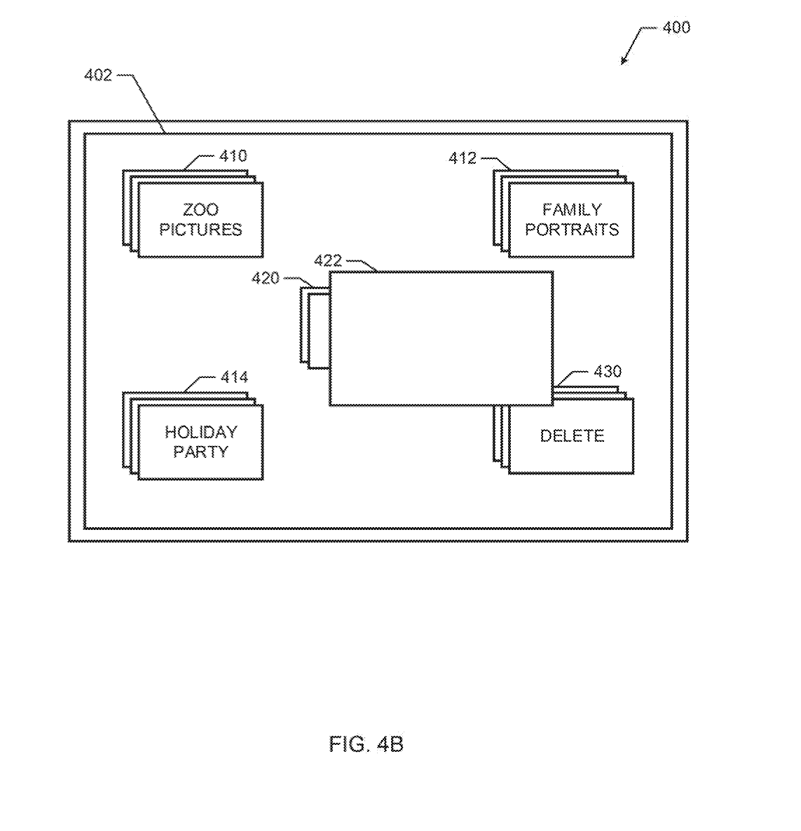

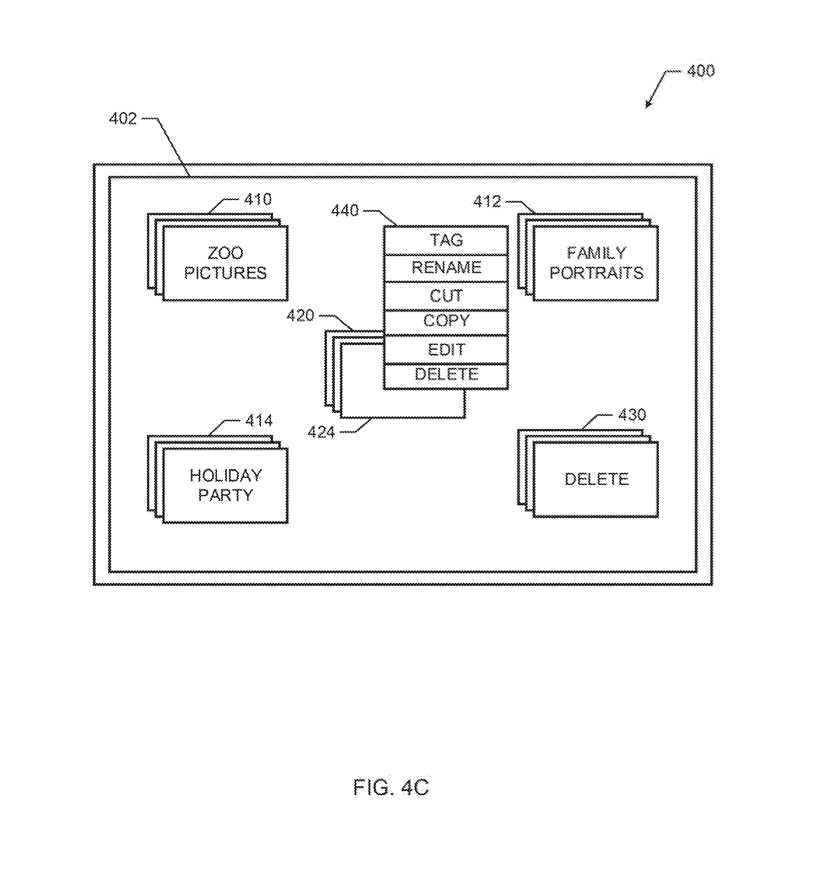

In some examples, the interface manager 220 may be implemented by a graphical user interface displayed on the media interface 110. The example graphical user interface (e.g., see FIGS. 4A-4C) may facilitate interaction with the media by displaying the media in various formats. For example, the media may be presented in groups (e.g., as sorted piles or sorted stacks), individually, and/or as part of a project (e.g., a slideshow presentation, video, etc.). The example interface manager 220 may also receive queries from users. An example query may include text identifying content of media, groups of media, types of media (e.g., sorted or unsorted), properties of media (e.g., color settings, exposure properties, pixilation, etc.) quality of media, time period of media, corresponding locations associated with media, locations of media within the media database 130, etc.

The example media organizer 230 sorts and/or organizes media in the media database 130. For example, the media organizer 230 may assign media to a group or a plurality of groups. Such groups may include media having a particular characteristic such as being associated with at least one of a particular date, a particular time, a particular location, a particular person, a particular source, a particular event, a particular object, etc. The media organizer 230 may assign the media to groups based on tags and/or identifiers applied to the media indicating the designated characteristics of the media. In some examples, the media organizer 230 may identify media that is not sorted into groups (e.g., a tag or identifier was not applied to the media by the media removal manager 210). In such examples, the media organizer 230 may instruct the interface manager 220 to alert the user that unidentified media was received.

In some examples, the media organizer 230 implements machine learning algorithms (e.g., clustering, Bayesian learning, similarity/metric learning, association rule learning, etc.) for sorting media into at least one group or into an unsorted group (i.e., the media is not sorted). For example, if the media organizer identifies that an image includes a particular set of tags (e.g., a tag identifying a user, a tag designating a particular location, and a tag designating a particular date), the media organizer may add that image to a designated group (e.g., Halloween Parties). In such an example, the media organizer 230 may recognize and/or learn that a particular group of media includes media having many of the same tags, and therefore, there is a likelihood that a newly received image having the same or similar tags could be added to that particular group.

The example project manager 240 of FIG. 2 facilitates project management control over the media. For example, the project manager 240 may be used to generate media into presentations (e.g., slideshows, video projects, audio projects, etc.). In some examples, the project manager 240 may generate a project (e.g., a slideshow) automatically based on tags and/or identifiers assigned to the media by the media removal manager 210 and/or media organizer 230. Furthermore, the project manager 240 may automatically edit and/or adjust media features (e.g., quality, size, hue, color, brightness, sharpness, shading etc.). For example, the project manager 240 may adjust mage settings such that all or some of the images in a slideshow appear to have similar features (e.g., all images in black and white, all images in sepia, all mages having a same size and/or quality, etc.). The example project manager 240 may also facilitate user edits of the media. For example, when an image is presented to a user (e.g., an image that has not been assigned to a designated group), the user may call the project manager 240 to present image editing controls for the image via the media interface 120.

While an example manner of implementing the media manager 110 of FIG. 1 is illustrated in FIG. 2, at least one of the elements, processes and/or devices illustrated in FIG. 2 may be combined, divided, re-arranged, omitted, eliminated and/or implemented in any other way. Further, the media remove manager 210, the interface manager 220, the media organizer 230, the project manager 240 and/or, more generally, the example media manager 110 of FIG. 2 may be implemented by hardware and/or any combination of hardware and executable instructions (e.g., software). Thus, for example, any of the media analyze 210, the interface manager 220, the media organizer 230, the project manager 240 and/or, more generally, the example media manager 110 could be implemented by at least one of an analog or digital circuit, a logic circuit, a programmable processor an application specific integrated circuit (ASIC), a programmable logic device (PLD) and/or a field programmable logic device (FPLD). Further still, the example media manager 110 and/or media removal manager 210 of FIG. 2 may include at least one element, process, and/or device in addition to, or instead of, those illustrated in FIG. 2, and/or may include more than one of any or all of the illustrated elements, processes and devices.

FIG. 3 is a block diagram of an example media removal manager 210 that may be used to implement the media removal manager 210 of the media manager 110 of FIG. 2. The example media removal manager 210 of FIG. 3 includes a metadata manager 310, a content identifier 320, and a tagger 330. An example communication bus 340 facilitates communication between the metadata manager 310, the content identifier 320, and/or the tagger 330. The example media removal manager 210 of FIG. 3 analyzes media via the metadata manager 310 and the content identifier 320 and applies a tag to media via the tagger 330 based on analyzed metadata and content of the media.

The example metadata manager 310 of FIG. 3 extracts metadata associated with media from a media data including media (e.g., an image, a video, an audio clip, etc) and the metadata The example media data may be created and/or received (e.g., from a camera or other device) by the media manager 110 of FIGS. 1 and/or 2. The example metadata manager 310 may identify at least one of a time, a location, a format, a size, a quality, etc, corresponding to an image and provide such information to the tagger 330. In some examples, the metadata manager 310 may identify a pre-selected tag for media that was assigned by a user (e.g., prior to taking a picture, prior to creating an image, etc.). In such examples, the pre-selected tag may be used for sorting and/or organizing the media associated with the pre-selected tag and/or tagging the media associated with the pre-selected tag for removal after a period of time. The example metadata analyzed by the metadata manager 330 may be included in media data stored and/or generated in response to creating an image.

The example content identifier 320 of FIG. 3 analyzes the media in received media data to identify content (e.g., objects, persons, text, characters, etc.). The example content identifier may include an image processor to analyze images and/or video images. For example, the image processing by the content identifier 320 may identify pixels and/or features of the media that make identifiable images. In some examples, facial recognition may be implemented to identify an individual person. Accordingly, the content identifier 320 may use any suitable image processing techniques to identify particular content within the media. In some examples, the content identifier 320 may perform a signal processing to identify particular sounds, images, etc. within the media. For example, the content identifier 320 may employ voice recognition techniques to identify a particular individual.

The example tagger 330 of FIG. 3 assigns tags (e.g., identifiers, such as numbers, symbols, names, etc.) to media (e.g., similar to metadata) based on content and/or metadata received from the content identifier 320 and/or metadata manager 310. The tagger 330 may consult a tagging database that stores information associated with particular content and/or metadata. Such a database may be located within the media manager 110 and/or within the media database 130 of FIG. 1. Accordingly, the tagger 330 may assign a same tag to media having at least some of the same and/or similar metadata and/or content. For example, if the metadata manager 310 determines that a first image was taken at a particular location, the tagger 330 may apply a tag corresponding to that particular location to the media data. In such an example, if a subsequent image is received that was taken at the same location (as determined by the metadata manager 310), the tagger 330 may apply the same tag to that particular location. In this example, the tagger 330 may create a database entry after receiving the first image that identifies that location and the tag to be applied for that location, then the tagger 330 may retrieve that tag when the second image is received and apply the tag to the second image. The example tags assigned to the images by the tagger 330 may be stored as metadata along with the images in the media database 130 of FIG. 1.

In some examples, the media removal manager 210 of FIG. 3 may be used to identify unwanted images and/or images that a user is likely to delete (i.e., the user desires to temporarily keep the images). For example, such images may not belong to any identifiable group and/or tag associated with other media in the media database. As a specific example, an unwanted image may include a product that a user captures in a store for temporary shopping reasons (e.g., to show to another individual, to compare to another item, etc.). In such an example, the tagger 330 may use information from the metadata (e.g., location information indicating the image was taken in or near a store, time information, etc.) and/or content information (e.g., an image processor identifies an object, such as, a product for sale, a bar code, etc.) to determine that the image is likely not an image that a user wishes to keep permanently or for a substantial length of time. In such examples, the tagger 330 may assign a tag to the media corresponding to temporary media (e.g., pictures to be deleted) so that a user may identify such media for quick removal from the media database 130. For example, a user may input a query for the temporary images, and the temporary images may be presented to the user for review and/or deletion.

In some examples, the tagger 330 may assign a tag that causes the media manager 110 to automatically remove the image from the media database 130 after a particular period of time (e.g., 1 day, 1 week, 1 month, etc.). Such a period of time may be adjustable via the interface manager 220 and/or the media interface 120 In some examples, media manager 110 may implement machine learning techniques to learn a user's behavior regarding deleting media from a media database. For example, if a user frequently deletes media in the media database 130 having a particular content, metadata, and/or that is assigned to a different group after a period of time, the media manager 110 may automatically delete and/or request to delete the same or similar media from the media database 130.

While an example manner of implementing the media removal manager 210 of FIG. 2 is illustrated in FIG. 3, at least one of the elements, processes and/or devices illustrated in FIG. 3 may be combined, divided, re-arranged, omitted, eliminated and/or implemented in any other way. Further, the metadata manager 310, the content identifier 320, the tagger 330 and/or, more generally, the example media removal manager 210 of FIG. 3 may be implemented by hardware and/or a combination of hardware and software. Thus, for example, any of the metadata manager 310, the content identifier 320, the tagger 330 and/or, more generally, the example media removal manager 210 could be implemented by at least one of an analog or digital circuit, a logic circuit, a programmable processor, an application specific integrated circuit (ASIC), a programmable logic device (PLD) and/or a field programmable logic device (FPLD). At least one of the metadata manager 310, the content identifier 320, and/or the tagger 330 is/are hereby expressly defined to include a tangible computer readable storage medium, storage device, or storage disk such as a memory, a digital versatile disk (DVD), a compact disk (CD), a Blu-ray disk, etc. storing executable instructions (e.g., software and/or firmware) and/or a processor to execute the executable instructions. Further still, the example media removal manager 210 of FIG. 3 may include at least one element, process, and/or device in addition to, or instead of, those illustrated in FIG. 3, and/or may include more than one of any or all of the illustrated elements, processes and devices.

FIGS. 4A-4C illustrate example implementations of an example graphical user interface 400 for interacting with the media manager 110 of FIGS. 1 and/or 2. The graphical user interface 400 may serve as an example “virtual photo table” to enable a user to view media, access media, sort media, edit media, delete media, and/or create projects with media. The graphical user interface 400 of FIGS. 4A-4C is illustrated on an example display 402, which may be implemented by the media interface 120 of FIG. 1.

The graphical user interface 400 in the illustrated examples of FIGS. 4A-4C includes three groups of sorted media 410, 412, 414 (illustrated in stacks or piles on the graphical user interface), a group of unsorted media 420, and a delete group 430. Though only five groups of media 410, 412, 414, 420, 430 are illustrated in FIGS. 4A-4C, many other groups of media may be illustrated. The example groups of media 410, 412, 414, 420, and/or 430 may be represented by example icons (e.g., thumbnails, media file identifiers, etc.). The example icons may include an image (e.g., a thumbnail) from at least one media file in the corresponding group of media.

The example unsorted media 420 may represent at least one media file that the media removal manager 210 and/or media organizer 230 do not determine to be a particular group of media to which the unsorted media 420 s to be assigned. Accordingly, the unsorted media 420 is presented separately from the grouped media 410, 412, 414. For example, such media may include images, video, and/or audio clips with metadata that the media removal manager 210 does not recognize as corresponding to a particular tag used for the media groups 410, 412, 414. In some examples, the media manager 110 via the graphical user interface 400 may suggest a particular group 410, 412, 414 to which the unsorted media 420 may be assigned (i.e., the media manager 110 makes a best guess at which group an image may be assigned to).

The example delete group may include media that is to be deleted upon instructions from a user, upon shut down, after a designated period of time, etc. Accordingly, the delete group 430 may be accessed and/or edited prior to media within the delete group 430 being removed from the media database 430.

The illustrated example of FIG. 4A may be considered a main screen of the graphical user interface 400. For example, the media groups 410-430 of FIG. 4A-4C may represent a sorted layout of all images in the media database 130 of FIG. 1 that a user may access and/or manually sort. In some examples, the graphical user interface 400 of FIG. 4A-4C may represent an illustration of a sorted layout after a user input a query for particular media. For example, the sorted groups 410, 412, 414 may be presented in response to a user querying for media including a particular person and/or time. In response to the query, the example media manager 110 may present the example sorted groups 410, 412, 414 as they include media corresponding to the queried person and/or time (e.g., a same person was in the zoo pictures 410, the family portraits 412, and the holiday party media 414). In some examples, the graphical user interface 400 of FIG. 4A may be presented in response to selecting a group of images (e.g., one of the groups 410, 412, 414, 420, 430) to view the images and/or view a further tier of the images. For example, an additional hierarchy of sorted images may be included within the family portraits group that includes a plurality of groups for each family member's portraits (not shown).

In the illustrated example of FIG. 4A, a user may “drag and drop” images between groups 410, 420, and/or 430. For example, in FIG. 4A, an image presented on the top of the unsorted media stack 420 may be dragged and dropped into a holiday party group 410 if a user wants the image to be assigned a tag corresponding to the holiday party group 410. In such an example, the tagger 330 may assign a tag to the previously unsorted media image such that the media will be presented in the corresponding group in future queries and/or layouts. In the illustrated example of FIG. 4A, a same media file may be included in more than one group 410. For example, the holiday party group 410 and the family portraits group 410 may both include a same media file. In such an example, the media file was assigned two tags corresponding to each of the holiday party group 410 and the family portraits group 410.

In the illustrated example of FIG. 4B, the graphical user interface 400 includes a zoomed in image of an unsorted media file 422 from the unsorted media group 420. The example interface manager 220 may facilitate pinch and zoom gestures and/or other gestures to enable ease of viewing and/or accessing media via the graphical user interface 400. In some examples, the interface manager 220 may facilitate rotation of a media file, resizing of a media image, etc. Accordingly, the graphical user interface 400, as illustrated in FIG. 4B, allows a user to more thoroughly examine images prior to adding the images to a particular group and/or selecting a particular group of images.

In the illustrated example of FIG. 4C, the graphical user interface includes a pop-up menu 440 displaying media options for a particular unsorted media file 424. The example pop-up menu 440 may be displayed in response to a user tapping and holding the media file 424 (and/or media group for a period of time). In the illustrated example of FIG. 4C, the pop-up menu 440 may enable the user to tag the media file 424 (e.g., assign the particular image to a designated group), rename a media file 424, cut the media file 424, copy the media file 424, edit the media file 424, and/or delete the media file 424. In some examples, different options may appear on the pop-up menu 440 depending on the type of media file selected (e.g. image vs, video vs. audio, sorted vs. unsorted, etc.). In some examples, a pop-menu 440 may be used to create a new group, for example, when a portion of the graphical user interface is selected that does not correspond to any of the groups 410, 412, 414, the unsorted group 420, and/or the delete group 430. The example pop-up menu 424 may be used to identify metadata corresponding to the media. Accordingly, a user may identify when, where, quality, properties, etc. of a particular media file. For example a user may desire to refer to such information when determining where an image is to be sorted and/or how an image is to be manually tagged. In another example, a user may identify metadata data that is common to a particular group. For example, a user may bring up metadata for a group via a pop-menu 424 by pressing and holding an icon of the group, and the metadata common to all media in the group may be displayed. Accordingly, a user may quickly perform and/or access particular tasks using a pop-up menu 440 on the graphical user interface 400.

Other example implementations to facilitate access, viewing, editing, sorting, deleting, etc. of the media in the media database 130 may be used alternatively or additionally to those illustrated in the examples of FIGS. 4A-4C. The examples of FIGS. 4A-4C illustrate a graphical user interface 400 that enables a user to quickly and efficiently identify media without a need to search through a plurality of folders, files, directories, etc. Rather, in response to a query and/or opening the graphical user interface 400, a user may be presented with media that was pre-sorted by the media manager 110 and/or previously sorted by the user.

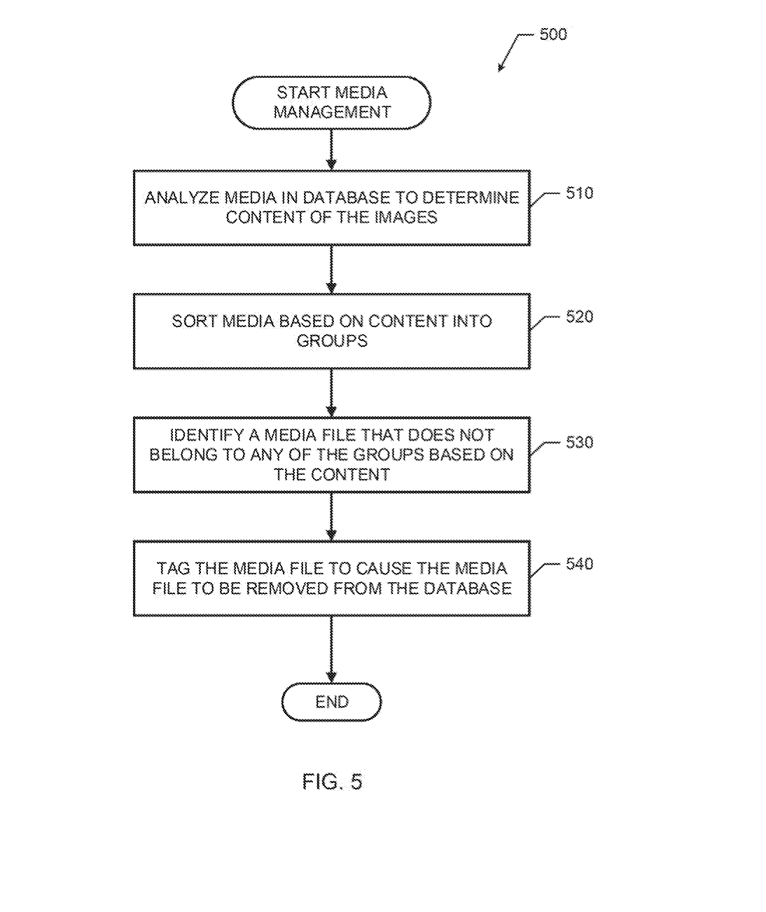

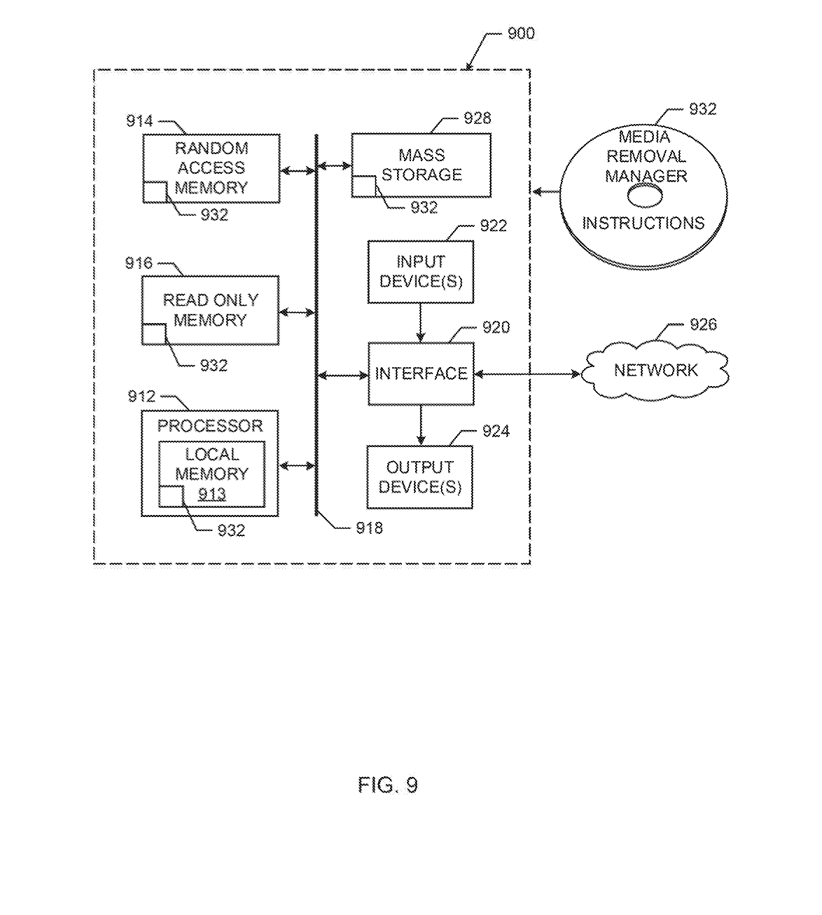

Flowcharts representative of example machine readable instructions for implementing the media manager 110 of FIG. 2 and/or media removal manager 210 of FIG. 3 are shown in FIG. 5, 6, 7 and/or 8. In this example, the machine readable instructions comprise a program/process for execution by a processor such as the processor 912 shown in the example processor platform 900 discussed below in connection with FIG. 9. The program/process may be embodied in software stored on a tangible computer readable storage medium such as a CD-ROM, a floppy disk, a hard drive, a digital versatile disk (DVD), a Blu-ray disk, or a memory associated with the processor 912, but the entire program/process and/or parts thereof could alternatively be executed by a device other than the processor 912 and/or embodied in firmware or dedicated hardware. Further, although the example program is described with reference to the flowcharts illustrated in FIG. 5, 6, 7 and/or 8, many other methods of implementing the example media manager 110 and/or media removal manager 210 may alternatively be used. For example, the order of execution of the blocks may be changed, and/or some of the blocks described may be changed, eliminated, or combined.

An example program 500 of FIG. 5 begins with an initiation of the media manager 110 (e.g., upon startup of the media manager 110, upon instructions from the media manager 110, upon startup of the media interface 120, upon startup of a device (e.g., tablet computer, smartphone, etc.) including the media manager 110, etc.). The example program 500 of FIG. 5 may be executed to automatically remove unsorted (and/or unwanted) media from a media database (e.g., the media database 130). At block 510, the example media removal manager 210 analyzes images in the media database 130 to determine content of the images. For example, the media removal manager 210 may analyze metadata of the media and/or perform signal/image processing to identify content of the media. In such examples, at block 510, the media removal manager 210 may assign tags to the images based on the determined content.

At block 520 of FIG. 5, the example media organizer 230 organizes the media based on the content of the groups. For example, at block 520, the example media organizer 230 may identify tags (e.g., tags assigned by the media removal manager 210) corresponding to the content of the groups and assign the media to the groups based on the tags. At block 530, the content identifier 320 and/or tagger 330 identifies a media file that does not belong to any of the groups (e.g., the media files 422, 424 or any of the media in the unsorted group 420 of FIGS. 4A-4C based on the content of the media and/or the content of the media in the plurality of groups. In some examples, at block 530, the media organizer 230 may determine that the media file was not assigned a particular tag and/or includes content that was not associated with a particular tag. At block 540, the tagger 330 of the media removal manager 210 tags the media file to cause the media file to be removed from the database After block 540, the example program 500 of FIG. 5 end.

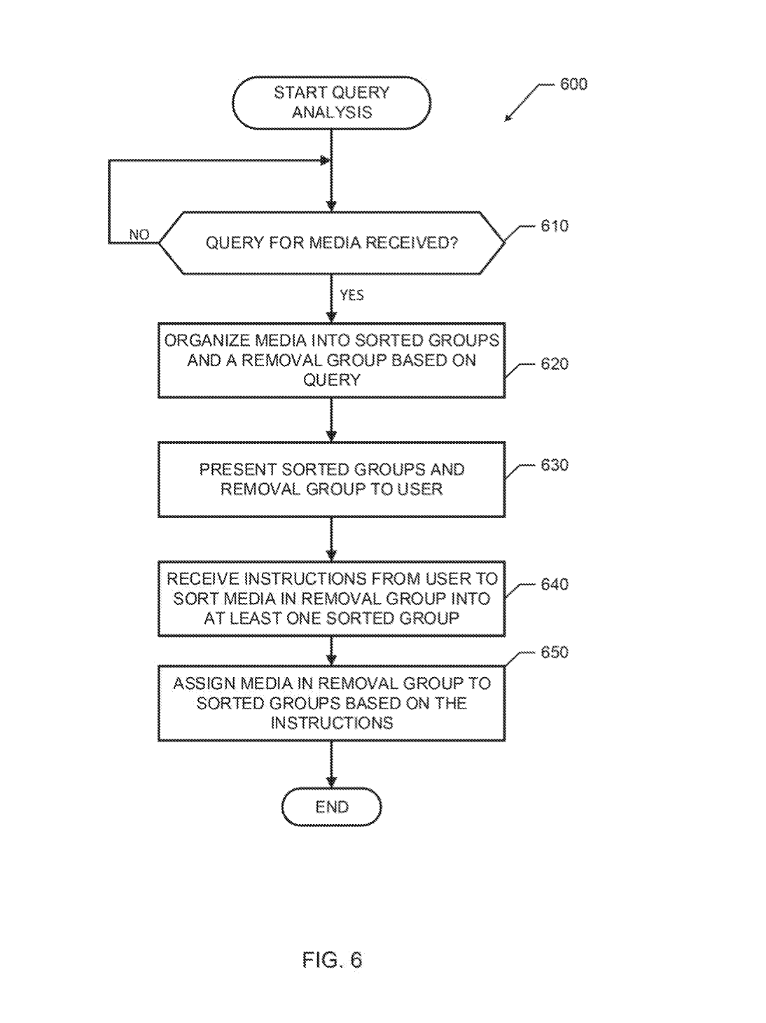

An example program 600 of FIG. 6 begins with an initiation of the media manager 110. The example program 600 of FIG. 6 may be executed to present and/or sort media in a media database (e.g., the media database 130 of FIG. 1). The example program 600 of FIG. 6 may be executed simultaneously and/or consecutively with the program 500 of FIG. 5. At block 610, the interface manager 220 of the media manager 110 determines whether a query for media was received from a user. For example, at block 610, the interface manager 220 may monitor an input (e.g., a keyboard, a touchpad, a touchscreen, etc.) of the media interface 120. If a query is not received at block 610, the interface manager 220 and/or media manager 110 continue to monitor for a query from the user (control returns to block 610). If a query for media is received at block 610, the media organizer 230 sorts media into sorted groups (e.g., the groups 410, 412, 414 of FIGS. 4A-4C) and a removal group (e.g., an unsorted group, i.e., a group of media that does not belong to any other group of media in a database) based on the query (block 620). For example, if a query is made for a person, a plurality of groups including media from a plurality of events with the person may be presented along with a removal group of images that do or do not include that particular person. In some examples at block 610, the query may be made for the images to be removed (i.e., images in the removal group). In such examples, the sorted groups may include all sorted groups of media created by the media manager 110 as disclosed herein and/or by the user.

At block 630, the interface manager 220 (via the media interface 120) presents the sorted groups and the removal group to a user. At block 640, the interface manager 220 receives instructions from the user to sort media in the removal group into at least one of the sorted group. For example, at block 640, the interface manager 220 may have determined that a user dragged and dropped an image presented in the removal group into a sorted group on a graphical user interface (e.g., the graphical user interface 400). At block 650, the media organizer 230 assigns the media from the removal group to at least one of the sorted groups based on the instructions from the user. For example, the media organizer 230 may assign a tag corresponding to a particular group to the previously removal media. In some examples, the media organizer 230 may assign the media to a new group as a particular group may not be created for the image at that point. After block 650, the program 600 ends.

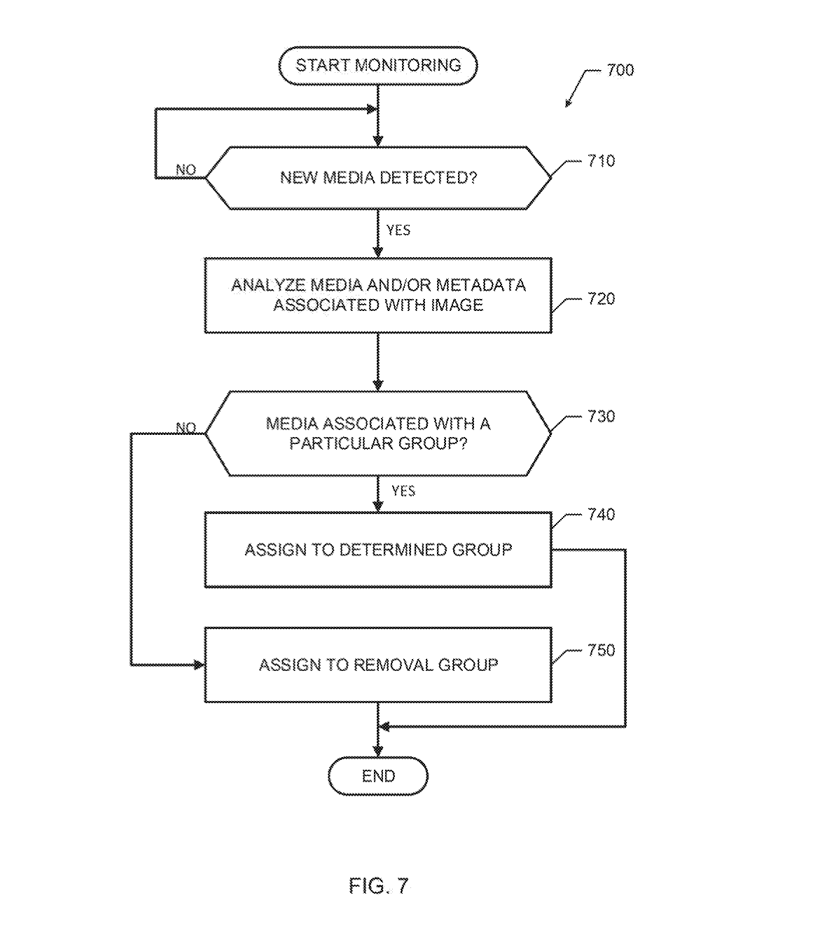

An example program 700 of FIG. 7 begins with an initiation of the media manager 110 and/or media removal manager 210. The example program 700 of FIG. 7 may be executed to monitor for new media (e.g., media added to the media database 130) and assign the new media to a group based on content of the media. At block 710, the media manager 110 determines whether new media has been detected in the media database 130. If no new media has been detected, the media manager 110 continues to monitor the media database 130 for new media (control returns to block 710). If new media is detected at block 110, the media removal manager 210 analyzes the media and/or metadata associated with the media at block 720. At block 730, the example media removal manager 210 determines whether the media is associated with a particular group. For example, at block 730, the media removal manager 210 determines whether content of the media and/or metadata of the media corresponds to a designated tag. If, at block 730, media is associated with a particular group, at block 740, the tagger 330 of the media removal manager 210 assigns a tag to the media and the media organizer 230 assigns the media to the determined group.

If at block 730 of FIG. 7, the media is not associated with a particular group, at block 750, the media manager 110 and/or media removal manager assign the media to a removal group (and/or an unsorted group). For example, at block 750 the media may be assigned to a removal group by not tagging the media with a tag and/or by assigning the media with a tag representative of the media being not associated with any group. After block 740 and/or 750, the program 700 of FIG. 7 ends.

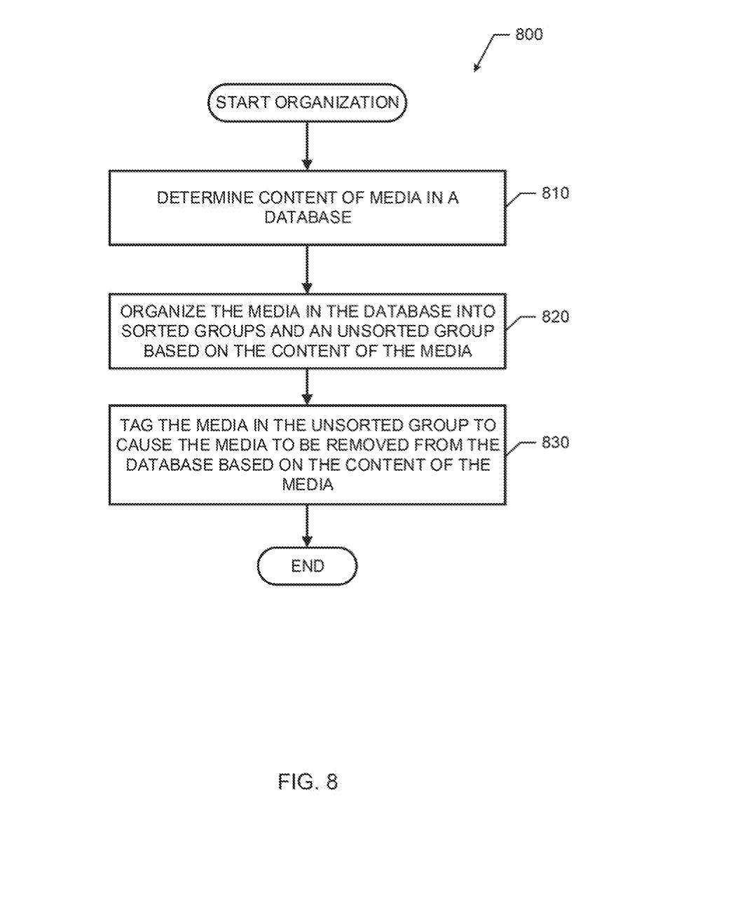

An example program 800 of FIG. 8 begins with an initiation of the media manager 110. The example program 800 of FIG. 8 may be executed to present sorted and/or unsorted media to a user. At block 810, the example media removal manager 210 determines content of media in a database (e.g., the database 130). For example, the media removal manager 210 may perform an image processing (e.g., facial recognition, signal processing, etc.). At block 820, the example media organizer 230 organizes the media into sorted groups and an unsorted group based on the content of the media. The example unsorted group may include media that does not belong to any of the sorted groups based on the content and/or metadata associated with the media. At block no, the tagger 330 and/or media organizer 230 may tag the media in the unsorted group to cause the media to be removed from the database based on the content of the media. Accordingly, media that does not correspond to a particularly group may automatically be removed from the database.

As mentioned above, the example processes of FIGS. 5, 6, 7, and/or 8 may be implemented using coded instructions (e.g., computer and/or machine readable instructions) stored on a tangible computer readable storage medium such as a hard disk drive, a flash memo, a read-only memory (ROM). a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5, 6, 7, and/or 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. As used herein the term “a” or “an” may mean at least one and therefore, “a” or “an” do not necessarily limit a particular element to a single element when used to describe the element.

FIG. 9 is a block diagram of an example processor platform 900 capable of executing the instructions of FIGS. 5, 6, 7, and/or 8 to implement the media manager 110 of FIG. 2 and/or the media removal manager 230 of FIG. 3. The example processor platform 900 may be or may be included in any type of apparatus, such as a server, a personal computer, a mobile device (e.g., a cell phone, a smart phone, a tablet, etc.), a personal digital assistant (PDA), an Internet appliance, a DVD player, a CD player, a digital video recorder, a Blu-ray player, a gaming console, a personal video recorder, a set top box, or any other type of computing device.

The processor platform 900 of the illustrated example of FIG. 9 includes a processor 912. The processor 912 of the illustrated example is hardware. For example, the processor 912 can be implemented by at least one integrated circuit, logic circuit, microprocessor or controller from any desired family or manufacturer.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, at least one input device 922 is connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device 924 is also connected to the interface circuit 920 of the illustrated example. The output device(s) 924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes at least one mass storage device 928 for storing software and/or data. Examples of such mass storage device(s) 928 include floppy disk drives, hard drive disks, compact disk drives, Blu-ray disk drives. RAID systems, and digital versatile disk (DVD) drives.

The coded instructions 932 of FIGS. 5, 6, 7, and/or 8 may be stored in the mass storage device 928, in the local memory 913 in the volatile memory 914, in the non-volatile memory 916, and/or on a removable tangible computer readable storage medium such as a CD of DVD.

From the foregoing, it will be appreciated that the above disclosed methods, apparatus and articles of manufacture provide automatic organization of media and/or interaction with media via a graphical user interface to implement a media table (e.g., a photo table) that provides ease of accessing media, viewing media, editing media, sorting media, assigning metadata to media, and/or deleting media. As disclosed herein, media may be sorted and/or organized into groups based on both metadata and/or content of the media. In some examples, media may be temporarily kept in a media database before being removed from the media database based on content and/or metadata associated with the media. Examples disclosed herein facilitate ease of access to a user's media portfolio using queries and/or other commands. In examples disclosed herein, projects, such as slideshows or other presentations, may be automatically generated using sorted media. In some examples disclosed herein, machine learning may be implemented to learn and/or understand a user's preferences when sorting media and/or displaying media.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
analyzing, via a processor, media in a database to determine content of the media;
sorting the media based on the content into a plurality of groups;
identifying a media file that does not belong to at least one of the plurality of groups based on content of the media file and the content of the media; and
in response to identifying that the media file does not belong to at least one of the plurality of groups, tagging the media file to cause the media file to be removed from the database.

2. A method as defined in claim 1, further comprising tagging the media file to cause the media file to be removed from the database based on the content of the media file and the metadata of the media file, the metadata comprising at least one of a time associated with media of the media file or a location associated with media of the media file

3. A method as defined in claim 1, wherein sorting the media is further based on at least one of a time associated with the media, a location associated with the media, an event associated with the content of the media, a quality of the media, or a property of the media.

4. A method as defined in claim 1, further comprising:
presenting the media file and a plurality of icons representative of the plurality of groups to a user, wherein the user is capable of assigning the media file to at least one of a group of the plurality of groups a new group or a delete group.

5. A method as defined in claim 6, wherein presenting the media file to the user comprises alerting the user that the media file is at least one of newly added to the database, tagged for removal, or does not belong to at least one of the plurality of groups.

6. A method as defined in claim 1, further comprising:
monitoring the database for a new media file; and
in response to detecting the new media file:
analyzing the new media file to determine content of the new media file; and
sorting the new media file into at least one group of the plurality of groups.

7. A method as defined in claim 1, wherein the media file comprises a plurality of media files, wherein a first media file of the plurality of media files and a second media file of the plurality of media files are tagged for removal and the first media file and the second media file have at least different content or different metadata.

8. An apparatus comprising:
a metadata manager to identify metadata associated with media in a database;
a content identifier to determine content of the media for sorting the media into a plurality of groups; and
tagger to tag the media with identifiers corresponding to the plurality of groups and to tag the media to cause the media to be removed from the database when it is determined that the media does not belong to one of the plurality of groups.

9. The apparatus as defined in claim 8, wherein the tagger causes the media that does not belong to one of the plurality of groups to be removed after a period of time.

10. The apparatus as defined in claim 8 wherein the tagger causes the media to be removed to be presented to a user prior to removal.

11. The apparatus as defined in claim 8 wherein the content identifier is to determine content of the media by processing the media to identify at least one of an object within the media, a person within the media, or a source of the media.

12. The apparatus as defined in claim 8, wherein the metadata manager is to identify a pre-selected tag associated with the media and the tagger is to cause the media to be removed based on the pre-selected tag.

13. A non-transitory computer readable storage medium comprising instructions that, when executed cause a machine to at least:
determine content of media in a database
organize the media in the database into sorted groups and an unsorted group based on the content of the media, the unsorted group comprising media that does not belong to the sorted groups based on the content; and
tag the media in the unsorted group cause removal from the database based on the content of the media.

14. The non-transitory computer readable storage medium of claim 13, wherein the instructions when executed further cause the machine to present the media in the unsorted group prior to removal from the database.

15. The non-transitory computer readable storage medium of claim 13, wherein the instructions when executed cause the machine to determine whether a new group is to be created for the media by comparing the media to other media in the database based on whether the other media includes at least one of content similar to the content of the media, an associated time similar to the time associated with the media, or an associated location similar to the location associated with the media.
